(19) United States
(12) Patent Application Publication
(10) Pub. No.: US 2009/0110462 A1
(43) Pub. Date: Apr. 30, 2009

(54) METHOD AND APPARATUS FOR STABILIZING PRINTABLE MEDIA IN A PRINTER

(76) Inventors: Stacy Leigh Arrington, Raleigh, NC (US); Richard Hunter Harris, Raleigh, NC (US); Dean Frederick Herring, Youngsville, NC (US); Robert Andrew Myers, Cary, NC (US)

Correspondence Address: DUKE W. YEE;YEE & ASSOCIATES, P.C., P.O. BOX 802333, DALLAS, TX, 75380, US

(21) Appl. No.: 11/932,279

(22) Filed: Oct. 31, 2007

(51) Int. Cl. B41J 11/70

(52) U.S. Cl. 400/621

(57) ABSTRACT

The illustrative embodiments described herein provide a method and apparatus for stabilizing printable media in a printer. The apparatus includes a platen for conveying printable media through a conveyance path. The apparatus also includes a set of guides for curving the printable media to form a stabilized printable media, wherein curving the printable media comprises decreasing a distance between a first longitudinal edge and a second longitudinal edge of the printable media.

### BACKGROUND OF THE INVENTION

1. Field of the Invention

The invention relates generally to a method and apparatus for managing printable media. More particularly, the present invention relates to a method and apparatus for introducing a curvature in printable media to stabilize printable media in a printer to reduce a likelihood of paper jams.

2. Description of the Related Art

Printers, such as point-of-sale printers, contain printable media for receiving printed text or graphics to form documents. Printable media is any material on which printed text or graphics may be printed. Printable media may include, without limitation, a roll of paper, a roll of heat-sensitive paper, one or more pre-cut paper sheets, a roll of flat, transparent plastic, carbon paper, or photographic paper.

In many printers, during the printing process, printable media is advanced along a paper conveyance path. The paper conveyance path is a path leading from the source of the printable media, across a printing assembly that generates the printed material, and ends at a document tray where the document may be retrieved. Paper jams prevent the printed document from being advanced to the document tray.

In retail environments, paper jams in point-of-sale printers reduce the throughput of customers in a particular checkout lane. Customers get frustrated waiting for cashiers to diagnose the cause of the paper jam, clear the paper jam, re-feed the printable media through the printer, and reprint the receipt. Oftentimes, manager approval is required to reprint a receipt, causing additional delays. Further, paper jams unnecessarily consume resources. Ink, electricity, and printable media are wasted when a jammed receipt is thrown away and reprinted. A severe enough paper jam may damage or destroy a point-of-sale printer or subsequent attempts by employees to clear the paper jam may result in destruction of vital printer components.

One commonly used method for reducing the rate at which printable media causes obstructions in the paper conveyance path requires the use of thicker paper. Thicker paper, however, is more expensive. Furthermore, less paper may be placed on a paper roll, thereby increasing the number of times that the roll must be replaced. This situation may also introduce undesirable wait time, and increase the possibility that the printer may experience damage.

Other commonly recited methods, such as tightly constraining the printable media in the paper conveyance path, minimizing the path length between the printhead and cutter, and adding guides to support the margins of the printable media, all require substantial modifications to the components of the printer or introduce additional opportunities for the paper to jam. Therefore, it would be advantageous to have a method and apparatus that overcomes these problems.

### BRIEF SUMMARY OF THE INVENTION

The illustrative embodiments described herein provide a method and apparatus for stabilizing printable media in a printer. The apparatus includes a platen for conveying a printable media through a conveyance path. The apparatus also includes a set of guides for curving the printable media to form a stabilized printable media, wherein curving the printable media comprises decreasing a distance between a first longitudinal edge and a second longitudinal edge of the printable media.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in which the illustrative embodiments may be implemented;

FIG. 2 is a block diagram of a printer in which the illustrative embodiments may be implemented;

FIG. 3 is an exemplary printer in accordance with an illustrative embodiment;

FIG. 4 is a diagram of a side view of a printer cavity housing a printing assembly in accordance with an illustrative embodiment;

FIG. 5 is a top view of a printer assembly for stabilizing printable media in accordance with an illustrative embodiment;

FIG. 6 is a three-quarter view of a printer assembly for stabilizing printable media in accordance with an illustrative embodiment; and

FIG. 7 is a flowchart stabilizing printable media in accordance with an illustrative embodiment.

### DETAILED DESCRIPTION OF THE INVENTION

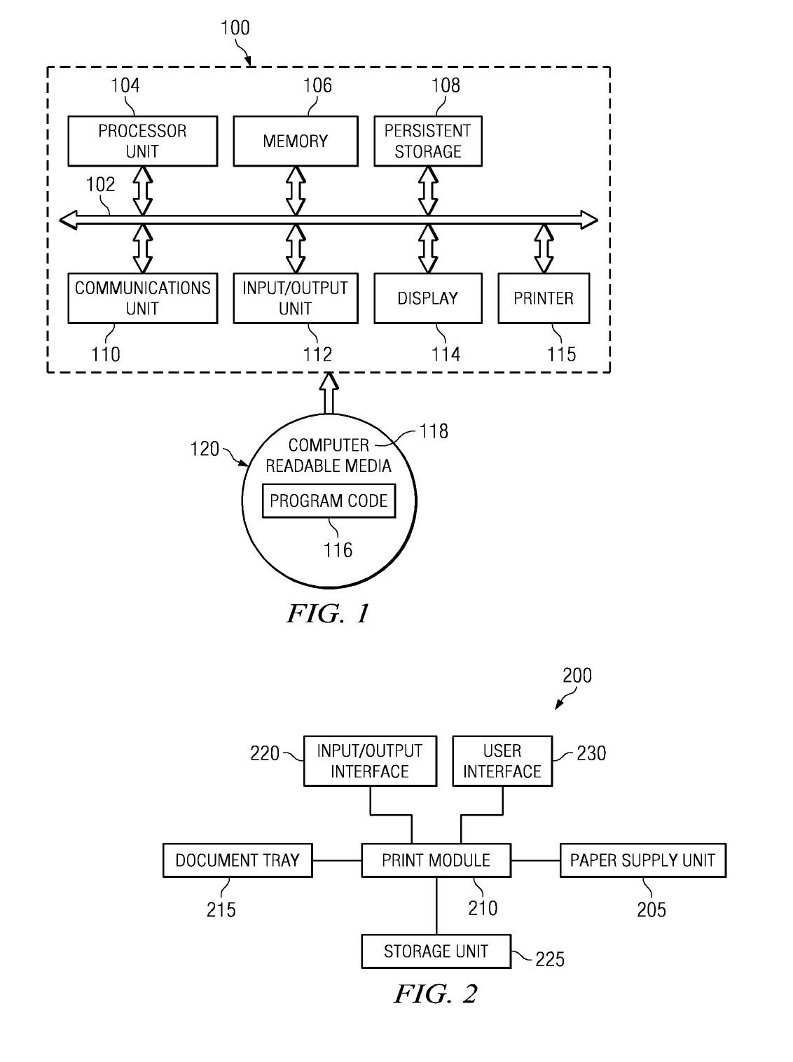

Turning now to FIG. 1, a diagram of a data processing system is depicted in accordance with an illustrative embodiment of the present invention. In this illustrative example, data processing system 100 includes communications fabric 102, which provides communications between processor unit 104, memory 106, persistent storage 108, communications unit 110, input/output (I/O) unit 112, display 114, and printer 115.

Processor unit 104 serves to execute instructions for software that may be loaded into memory 106. Processor unit 104 may be a set of processors or may be a multi-processor core, depending on the particular implementation. The use of the phrase “a set of” refers to one or more items. As an example a set of processors is one or more processors, and a set of guides is one or more guides. Further, processor unit 104 may be implemented using one or more heterogeneous processor systems in which a main processor is present with secondary processors on a single chip. As another illustrative example, processor unit 104 may be a symmetric multi-processor system containing multiple processors of the same type.

Memory 106, in these examples, may be, for example, a random access memory. Persistent storage 108 may take various forms depending on the particular implementation. For example, persistent storage 108 may contain one or more components or devices. For example, persistent storage 108 may be a hard drive, a flash memory, a rewritable optical disk, a rewritable magnetic tape, or some combination of the above. The media used by persistent storage 108 also may be removable. For example, a removable hard drive may be used for persistent storage 108.

Communications unit 110, in these examples, provides for communications with other data processing systems or devices. In these examples, communications unit 110 is a network interface card. Communications unit 110 may provide communications through the use of either or both physical and wireless communications links.

Input/output unit 112 allows for input and output of data with other devices that may be connected to data processing system 100. For example, input/output unit 112 may provide a connection for user input through a keyboard and mouse. Further, input/output unit 112 may send output to printer 115. Display 114 provides a mechanism to display information to a user.

Instructions for the operating system and applications or programs are located on persistent storage 108. These instructions may be loaded into memory 106 for execution by processor unit 104. The processes of the different embodiments may be performed by processor unit 104 using computer implemented instructions, which may be located in a memory, such as memory 106. These instructions are referred to as, program code, computer usable program code, or computer readable program code that may be read and executed by a processor in processor unit 104. The program code in the different embodiments may be embodied on different physical or tangible computer readable media, such as memory 106 or persistent storage 108. In one embodiment, the program code relates to printing a receipt on printer 115 for transactions that occur at a point of sale.

Printer 115 may be used to print any type of document. Instructions may be sent to printer 115 on communications fabric 102 to provide printer 115 with a set of parameters relating to the printing of one or more documents. These parameters may contain, for example, data that should be printed on a receipt to be printed by printer 115 at a point of sale. Also, because printer 115 is compatible with a variety of different operating systems, such as Microsoft Windows® or Unix®, instructions may be sent to printer 115 regardless of the operating system executing on data processing system 100. Microsoft and Windows are trademarks of Microsoft Corporation in the United States, other countries, or both. Unix is a registered trademark of The Open Group in the United States, other countries, or both. Printer 115 may be connected to one or more of the other components of the FIG. 1 via a direct connection, such as a bus, or over a network, such as the Internet.

Program code 116 is located in a functional form on computer readable media 118 and may be loaded onto or transferred to data processing system 100 for execution by processor unit 104. Program code 116 and computer readable media 118 form computer program product 120 in these examples. In one example, computer readable media 118 may be in a tangible form, such as, for example, an optical or magnetic disc that is inserted or placed into a drive or other device that is part of persistent storage 108 for transfer onto a storage device, such as a hard drive that is part of persistent storage 108. In a tangible form, computer readable media 118 also may take the form of a persistent storage, such as a hard drive or a flash memory that is connected to data processing system 100. The tangible form of computer readable media 118 is also referred to as computer recordable storage media.

Alternatively, program code 116 may be transferred to data processing system 100 from computer readable media 118 through a communications link to communications unit 110 and/or through a connection to input/output unit 112. The communications link and/or the connection may be physical or wireless in the illustrative examples. The computer readable media also may take the form of non-tangible media, such as communications links or wireless transmissions containing the program code.

The different components illustrated for data processing system 100 are not meant to provide architectural limitations to the manner in which different embodiments may be implemented. The different illustrative embodiments may be implemented in a data processing system including components in addition to or in place of those illustrated for data processing system 100. Other components shown in FIG. 1 can be varied from the illustrative examples shown.

For example, a bus system may be used to implement communications fabric 102 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 106 or a cache such as found in an interface and memory controller hub that may be present in communications fabric 102.

Turning now to FIG. 2, a block diagram of a printer is depicted in which the illustrative embodiments may be implemented. Printer 200 is a non-limiting example of printer 115 in FIG. 1. In this illustrative example, printer 200 may be any type of printer, such as, for example, a thermal printer, toner-based printer, liquid inkjet printer, solid ink printer, dye-sublimation printer, inkless printer, impact printer, daisy wheel printer, dot-matrix printer, line printer, or a pen-based plotter. Printer 200 may used in type of application, such as a point of sale printer, an office printer, or a home-use printer. A point of sale printer is sometimes referred to as a fiscal printer.

Printer 200 includes paper supply unit 205. Paper supply unit 205 holds printable media that is used by printer 200 to print documents. The printable media in paper supply unit 205 may take a variety of forms, such as a roll of printable media or a stack of pre-cut sheets of printable media. The printable media may be made of any material that is capable of being printed on by printer 200, such as paper or heat-sensitive material.

Printer 200 includes print module 210. Print module 210 is hardware in printer 200 that prints on the printer media to create a document. For example, print module 210 may apply ink to a paper in paper supply unit 205 using a toner. In another example, print module 210 uses thermal-printing techniques by selectively heating portions of a roll of heat-sensitive paper in paper supply unit 205. In another example, print module 210 applies ink to one or more sheets of pre-cut paper in paper supply unit 205.

Documents that are created in print module 210 exit printer 200 at document tray 215. The documents at document tray 215 may be retrieved by a user or by another device for processing.

Printer 200 includes input/output interface 220. Input/output interface 220 is an interface between the printer 200 and any external devices. Input/output interface 220 may be, for example, one or more ports into which a detachable storage device may be received. Input/output interface 220 may also be a connection port into which a computer, point of sale device, cash register, or any other data processing system is connected. For example, printer 200 may be connected to one or more of the components of data processing system 100, as shown in FIG. 1, via input/output interface 220.

Data received at input/output interface 220 may be sent to other components of printer 200 and used in the creation of documents. For example, transaction information may be sent to printer 200 at input/output interface 220 from a point of sale device so that a receipt may be printed using a roll of heat-sensitive paper in paper supply unit 205. This data may be buffered or otherwise stored in storage unit 225. Storage unit 225 may be random access memory, a hard drive, or detachment forms of memory.

Printer 200 also includes user interface 230. User interface 230 includes any controls that allow a user to adjust settings for printer 200. For example, user interface 230 may include controls that allow a user to select a type of paper in paper supply unit 205 to be used to create a document. User interface 230 may also include a control, such as a button or knob, which opens a cover of printer 200. The cover may enclose the paper in paper supply unit 205. Alternatively, user interface 230 may be displayed on a graphical user interface of data processing system that is connected to printer 200 via input/output interface 220.

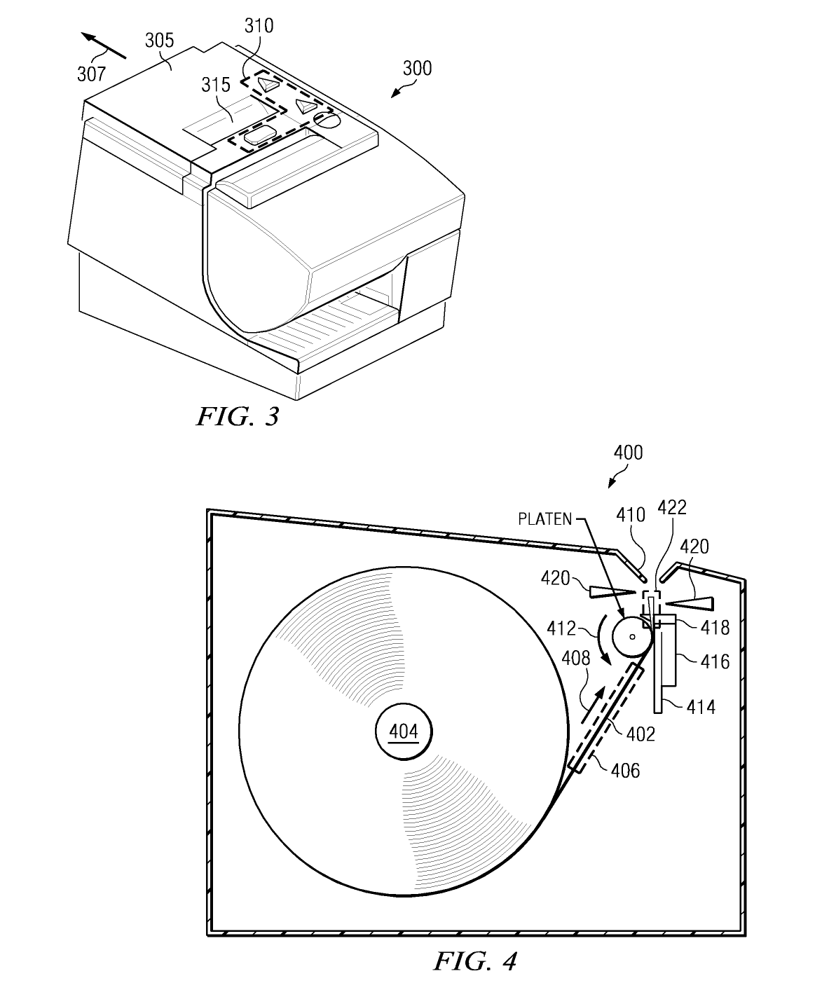

Turning now to FIG. 3, an illustration of a printer used to expose printable media is depicted in accordance with an illustrative embodiment. Specifically, FIG. 3 depicts printer 300, which is a non-limiting example of printer 115 in FIG. 1 and printer 200 in FIG. 2.

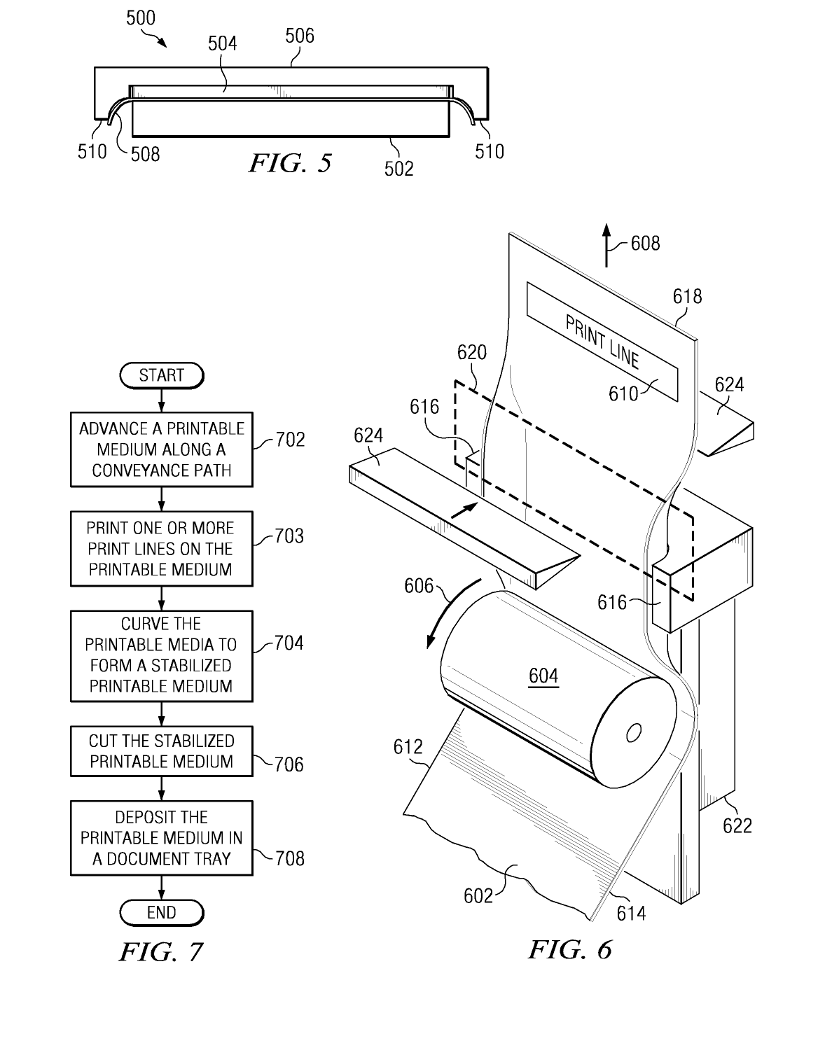

In one non-limiting example, printer 300 is a point of sale printer. Printer 300 includes cover 305. Cover 305 is coupled to printer 300 and conceals an area of printer 300 that contains a source of printable media, such as a roll of printer paper, and a printing assembly. The printing assembly, which is described in more detail in FIGS. 4 and 5 below, includes a platen, print head, and heat sink. Movement of cover 305 permits access to the printer cavity storing the printable media and the printing assembly.

As used herein, the term “couple” or “coupled” includes coupling via a separate object. For example, a cover may be coupled to a base if both the cover and the base are coupled to a third object. The term “coupled” also includes “directly coupled,” in which case the two objects touch each other in some way. The term “coupled” also encompasses two or more components that are continuous with one another by virtue of each of the components being formed from the same piece of material.

Cover 305 may be coupled to printer 300 in a variety of ways. For example, cover 305 may rest on printer 300 absent any type of connectors. In another example, one side of cover 305 may be pivotably coupled to printer 300 such that any particular side of cover 305 may be lifted, thereby revealing the contents of printer 300 concealed by cover 305. The pivotable coupling between cover 305 and printer 300 may include one or more hinges, screws, or bolts. Cover 305 may also be slidably coupled to printer 300 such that cover 305 may slide off of printer 300 in the direction indicated by arrow 307.

Cover 305 may be removed or opened in a variety of ways. For example, a user may manually move cover 305 into an open position. In another example, a user may open cover 305 using user interface controls 310. In this example, one of the buttons in user interface controls 310 may function to open cover 305. Cover 305 may also be opened by issuing instruction to printer 300 using a data processing system, such as data processing system 100 in FIG. 1.

Printer 300 also includes document tray 315. Document tray 315 is a non-limiting example of document tray 215 in FIG. 2. For example, transaction documents, such as receipts, which are printed using printer 300 may exit printer 300 and come to rest at document tray 315. A user may then retrieve these receipts at document tray 315.

The illustrative embodiments described herein provide a method and apparatus for stabilizing printable media in a printer. The apparatus includes a platen for conveying a printable media through a conveyance path. The apparatus also includes a set of guides for curving the printable media to form a stabilized printable media. Curving the printable media in these examples comprises decreasing a distance between a first longitudinal edge and a second longitudinal edge of the printable media. In addition, the apparatus may include a cutting device positioned in the conveyance path to cut the stabilized printable media.

In one embodiment, the printer is a thermal printer having a thermal printhead for generating printed matter onto a printable media. In this embodiment, the set of guides is one or more guiding members of a printing assembly for curving the printable media to form a stabilized printable media. Stabilized printable media is a printable media contorted in a shape imparting additional structural stability. The additional structural stability reduces the likelihood that the printable media will cause an obstruction in a conveyance path of the printer.

In particular, the set of guides may be guiding members affixed to or otherwise coupled with an existing heat sink. In another non-limiting embodiment, the set of guides may be coupled to a platen assembly. In an illustrative embodiment, the set of guides contacts the longitudinal edges of the printable media, thereby curving the printable media and decreasing a distance between the longitudinal edges of the printable media.

FIG. 4 is a diagram of a side view of a printer cavity housing a printing assembly in accordance with an illustrative embodiment. Printer 400 is a printing apparatus, such as printer 300 in FIG. 3.

Printer 400 is operable to transfer printable material onto printable media 402 to form printed documents. Printable media 402 is any material on which printed text or graphics may be printed. Printable media 402 may include, without limitation, a printer paper, a heat-sensitive paper, one or more pre-cut paper sheets, a roll of flat, transparent plastic, carbon paper, or photographic paper. Printable media 402 is stored in printer 400 as printable media source 404. In this illustrative example, printable media source 404 is a roll of printer paper. In other embodiments, printable media source 404 may be a ream of paper.

Printable media 402 is advanced along conveyance path 406 in the direction indicated by arrow 408. Conveyance path 406 is a path through printer 400 traveled by printable media 402. The beginning of conveyance path 406 is printable media source 404. The end of conveyance path 406 is document tray 410. Document tray 410 is a document tray such as document tray 315 in FIG. 3.

Conveyance path 406 traverses a printer assembly, such as printer assembly 500 in FIG. 5. In the illustrative example in FIG. 4, the printer assembly includes platen 412, printhead 414, heat sink 416, and set of guides 418.

Platen 412 advances printable media 402 along conveyance path 406. In this illustrative example in FIG. 4, platen 412 is a cylindrical roller powered by a motor (not shown) that causes platen 412 to rotate on an axis parallel to conveyance path 406. The contact of platen 412 with printable media 402 in conjunction with the rotation motion of platen 412 advances printable media 402 through printer 400 along conveyance path 406. In other words, platen 412 advances printable media 402 by impacting printable media 402 and rotating in an angular direction represented by arrow 408. This angular rotation advances printable media 402 along conveyance path 406.

Platen 412 impacts printable media 402 against printhead 414. Printhead 414 is a device that transfers printable material onto printable media 402. In an inkjet or dot matrix printer, printhead 414 is a printhead having one or more nozzles that transfers droplets of ink onto printable media 402. In this example, however, printhead 414 is a thermal printhead device having a heating element that causes an image to appear on printable media 402. Heat generated by printhead 414 is dissipated by heat sink 416.

Heat sink 416 is a device used to conduct and disperse heat generated by printhead 414. In this illustrative embodiment, heat sink 416 is modified to include set of guides 418. Set of guides 418 are guiding members of heat sink 416 that contact the longitudinal edges of printable media 402 for curving printable media 402 to form stabilized printable media 422. Stabilized printable media 422 is a portion of printable media 402 having a three-dimensional structural shape induced by set of guides 418. The structural shape provides printable media 402 structural stability. Cutter blades 420 cut stabilized printable media 422. Cutting stabilized printable media 422 reduces the likelihood of the paper jamming. Once cut, printable media 422 may be deposited in document tray for recovery by a user.

FIG. 5 is a top view of a printer assembly in accordance with an illustrative embodiment. Printing assembly 500 includes platen 502, printhead 504, and heat sink 506. Platen 502 is a platen, such as platen 412 in FIG. 4. Likewise, printhead 504 is a printhead, such as printhead 414 in FIG. 4. Similarly, heat sink 506 is a heat sink, such as heat sink 416 in FIG. 4.

Platen 502 impacts printable media 508 against printhead 504. The rotating motion of platen 502 advances printable media 508 from the source of the printable media (not shown) along the printing surface of printhead 504 to permit printhead 504 to transfer printable material onto printable media 508.

As platen 502 advances printable media 508 along a conveyance path, such as conveyance path 406 in FIG. 4, printable media 508 contacts set of guides 510. Set of guides 510 is a set of guides, such as set of guides 418 in FIG. 4. In this illustrative embodiment, set of guides 510 are guiding members of heat sink 506. As printable media 508 contacts set of guides 510, printable media 508 is curved so that a distance between the longitudinal edges of printable media 508 is decreased. The curvature of printable media 508 forms a stabilized printable media, such as stabilized printable media 422 in FIG. 4.

In this illustrative example, set of guides 510 are fashioned from the same material forming heat sink 506. However, in another non-limiting example, set of guides 510 may be constructed of a material less thermally conductive than heat sink 506. For example, set of guides 510 may be fashioned from a ceramic or plastic-type material and coupled or otherwise affixed to heat sink 506.

Furthermore, in another non-limiting example, the set of guides may be located separately from heat sink 506. For example, a set of guides may be coupled to a housing of platen 502. The housing of the platen is a structural component adapted to support platen 502 and enable platen 502 to rotate in an angular direction to advance printable media 508 along a conveyance path. In this example, the set of guides may curve printable media 508 away from platen 502.

FIG. 6 is a three-quarter view of a printer assembly for stabilizing printable media in accordance with an illustrative embodiment. Printing assembly 600 is a printing assembly such as printing assembly 500 in FIG. 5. Printing assembly 600 is adapted to convey printable media 602 from a source of printable media to a document tray, such as document tray 315 in FIG. 3, for retrieval.

Platen 604 rotates in an angular direction indicated by arrow 606. The rotation of platen 604 advances printable media 602 along conveyance path 608. As printable media 602 is advanced along conveyance path 608, printable media 602 impacts a printhead (not shown). The printhead transfers printable material onto printable media 602. The printed material is depicted as print line 610. In this illustrative example, print line 610 is a line of alphanumeric characters printed onto printable media 602 by a printhead. In this example, platen 604 is configured so that its length is as wide as print line 610. In other embodiments, platen 604 may be a length less than the width of printable media 602.

As printable media 602 advances along conveyance path 608, longitudinal edges 612 and 614 of printable media 602 are contacted with set of guides 616 and are curved so that a distance between longitudinal edges 612 and 614 is decreased. Set of guides 616 is a set of guides, such as set of guides 418 in FIG. 4 and set of guides 510 in FIG. 5. In this illustrative embodiment, set of guides 616 are guiding members protruding from a heat sink 622. Heat sink 622 is a heat sink, such as heat sink 416 in FIG. 4 and heat sink 506 in FIG. 5.

Longitudinal edges 612 and 614 are edges of printable media 602 which are parallel to conveyance path 608. In addition, longitudinal edges 612 and 614 are perpendicular to lateral edge 618. Lateral edge 618 is the leading edge of printable media 602 as printable media 602 is conveyed through a printer.

The curvature of printable media 602 creates stabilized printable media 620. Stabilized printable media 620 is a stabilized printable media such as stabilized printable media 422 in FIG. 4. Stabilized printable media 620 may then be cut by cutter blades 624. Cutter blades 624 are cutter blades, such as cutter blades 420 in FIG. 4. Once cut, the printed document may be deposited into a document tray, such as document tray 410 in FIG. 4.

Turning now to FIG. 7, a flowchart illustrating a process for stabilizing printable media is depicted in accordance with an illustrative embodiment. The process illustrated in FIG. 7 may be accomplished by a printing assembly, such as printing assembly 500 in FIG. 5.

The process begins by advancing a printable media along a conveyance path (step 702). The conveyance path traverses a printer assembly, such as printer assembly 500 in FIG. 5. The process prints one or more print lines on the printable media (step 703).

The printer assembly includes a set of guides, such as set of guides 510 in FIG. 5. The process then curves the printable media to form a stabilized printable media (step 704). The curvature of the printable media reduces the distance between the longitudinal edges of the printable media.

The process then cuts the stabilized printable media (step 706) and conveys the printable media to a document tray (step 708). The process terminates thereafter.

The flowcharts and block diagrams in the different depicted embodiments illustrate the architecture, functionality, and operation of some possible implementations of apparatus and methods. In this regard, each block in the flowchart or block diagrams may represent a module, segment, or portion of code, which comprises one or more executable instructions for implementing the specified function or functions. In some alternative implementations, the function or functions noted in the block may occur out of the order noted in the Figures. For example, in some cases, two blocks shown in succession may be executed substantially concurrently, or the blocks may sometimes be executed in the reverse order, depending upon the functionality involved.

The illustrative embodiments described herein provide a method and apparatus for stabilizing printable media in a printer. The apparatus includes a platen for conveying a printable media through a conveyance path. The apparatus also includes a set of guides for curving the printable media to form a stabilized printable media, wherein curving the printable media comprises decreasing a distance between a first longitudinal edge and a second longitudinal edge of the printable media. In addition, the apparatus may include a cutting device positioned in the conveyance path to cut the stabilized printable media.

The method and apparatus disclosed in the illustrative examples enable the creation of a stabilized printable media. The stabilized printable media may then be cut by a cutting device. Stabilizing the printable media reduces the likelihood that the printable media will become jammed as a result of the conveyance process. Reducing the likelihood of paper jams may save resources, such as paper and ink. In addition, where the printing apparatus is a fiscal printer located in a retail facility, reducing paper jams limits the amount of time that customers may have to wait in a checkout lane.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A printing apparatus comprising:
a platen for conveying printable media through a conveyance path; and
a set of guides for curving the printable media to form a stabilized printable media, wherein curving the printable media comprises decreasing a distance between a first longitudinal edge and a second longitudinal edge of the printable media.

2. The printing apparatus of claim 1, further comprising:
a cutting device positioned in the conveyance path to cut the stabilized printable media.

3. The printing apparatus of claim 1, wherein a length of the platen is less than a width of the printable media.

4. The printing apparatus of claim 3, wherein the length of the platen is a width of a print line on the printable media.

5. The printing apparatus of claim 1, wherein the set of guides are guiding members of a heat sink.

6. The printing apparatus of claim 5, wherein the set of guides are formed from material having a lower thermal conductivity than the heat sink.

7. The printing apparatus of claim 1, wherein the set of guides are guiding members coupled to a housing of the platen.

8. The printing apparatus of claim 1, further comprising:
a printing assembly in the conveyance path for printing printable subject matter on the printable media.

9. The printing apparatus of claim 8, wherein the printer is a thermal printer, and wherein the printing assembly comprises a thermal printhead.

10. The printing apparatus of claim 1, wherein the printing apparatus is a fiscal printer.

11. The printing apparatus of claim 1, wherein the cutting device is an automatic cutting device.

12. The printing apparatus of claim 1, wherein the cutting device comprises a stationary cutting blade and a movable cutting blade.

13. The printing apparatus of claim 1, further comprising:
a document tray.

14. The printing apparatus of claim 1, wherein the set of guides comprises two guides.

15. A method for managing printable media, the method comprising:
advancing a printable media along a conveyance path, wherein the conveyance path traverses a set of guides;
curving longitudinal edges of the printable media using the set of guides to form a stabilized printable media; and
cutting the stabilized printable media.

16. The method of claim 15, further comprising:
printing a print line on the printable media.

17. The method of claim 15, wherein curving the longitudinal edges of the printable media comprises at curving the printable media towards a platen.

18. The method of claim 15, wherein curving the longitudinal edges of the printable media comprises at curving the printable media away from a platen.

19. The method of claim 15, further comprising:
depositing the printable medium in a document tray.

20. A printing apparatus comprising:
a platen for conveying printable media through a conveyance path, wherein a length of the platen is less than the width of the printable media;
a set of guides for curving the printable media to form a stabilized printable media, wherein curving the printable media comprises decreasing a distance between a first longitudinal edge and a second longitudinal edge of the printable media, and wherein the set of guides protrudes from a heat sink; and
a cutting device positioned in the conveyance path to cut the stabilized printable media.
